(19) United States
(12) Patent Application Publication
(10) Pub. No.: US 2009/0147673 A1
(43) Pub. Date: Jun. 11, 2009

(54) STORAGE SYSTEM AND ROUTE SWITCH

(75) Inventor: Katsuya NIIGATA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/267,673

(22) Filed: Nov. 10, 2008

(30) Foreign Application Priority Data
Dec. 5, 2007 (JP) 2007-315029

(51) Int. Cl. G06F 11/00

(52) U.S. Cl. 370/225

(57) ABSTRACT

A storage system includes a route switch, connected to at least two different communication lines different in path between each of switches and the route switch. Upon detecting a fault on a communication line extending to the switch, the route switch converts a destination address of a frame into a modified address in accordance with an address conversion table. The route switch thus controls a frame exchanged between a calculation device and each of the switches.

### BACKGROUND

1. Field of the Invention

The present technique relates to a storage system including a route switch, connected to a plurality of storage devices, for controlling a frame exchanged between each storage device and a calculating device.

2. Description of the Related Art

Currently, most of calculating devices are typically connected to a storage system that stores reliably a vast amount of data and performs a variety of data processes by retrieving data stored on such a storage system.

FIG. 1 illustrates a configuration of a known storage system 10. As shown in FIG. 1, the storage system 10 includes calculating devices 11 and 12, a route switch 13, and networks 20 and 30. The network 20 includes switches 21 through 23, and the network 30 includes switches 31 through 33. The switches 21 through 23 are respectively connected to hard disk drives (HDDs) 21a through 23a and 21b through 23b, and the switches 31 through 33 are respectively connected to HDDs 31a through 33a and HDDs 31b through 33b.

The calculating devices 11 and 12 reads data from an HDD contained in one of the networks 20 and 30 and performs a variety of processes. The route switch 13 is connected to each of the calculating devices 11 and 12 and the networks 20 and 30. Upon retrieving a frame from one of the calculating devices 11 and 12 and the networks 20 and 30, the route switch 13 outputs the retrieved frame to a destination. Upon retrieving a frame, each of the switches 21 through 23 and switches 31 through 33 outputs the retrieved frame to the destination.

In order to retrieve data from the HDD 23a over the network 20, the calculating device 11 produces a frame addressed to the HDD 23a and then outputs the produced frame to the HDD 23a. The calculating device 11 thus retrieves the data from the HDD 23a.

Some known storage systems include duplicated communication lines to increase system reliability in addition to the configuration of FIG. 1 (as disclosed in Japanese Laid-open Patent Publication Nos. 2006-155392 and 2006-209549). FIG. 2 illustrates such a storage system having duplicated communication lines.

As shown in FIG. 2, a storage system 40 includes calculating devices 41 and 42, route switches 43 and 44, and networks 50 and 60. The network 50 includes switches 51 through 56, and the network 60 includes switches 61 through 66. The switches 51 through 56 respectively include HDDs 51a through 56a and HDDs 51b through 56b, and the switches 61 through 66 include HDDs 61a through 65a and HDDs 61b through 65b.

The calculating devices 41 and 42, the route switches 43 and 44, and the switches 51 through 56 and 61 through 66 are identical in function to the calculating devices 11 and 12, the route switch 13, and the switches 21 through 23 and 31 through 33 shown in FIG. 1, and the discussion thereof is omitted here.

Even if one communication line becomes faulty in the arrangement of FIG. 2, the other communication line can be used. The communication line between the calculating device and each HDD in the networks 50 and 60 is thus maintained.

If the communication line is duplicated as shown in FIG. 2, the two communication lines are frequently used at the same time even if no fault occurs. If one of the communication lines becomes faulty, communications performed by the faulty communication line is transferred to the other communication line.

If any trouble takes place in the communication line (such as cutting of a cable or faulty switch) in the known art, no communication line is present between a storage device (HDD) connected to the communication line in trouble and a calculating device and accessing to the HDD becomes difficult.

FIG. 3 illustrates the storage system of FIG. 1 having a fault on the communication line thereof.

FIG. 4 illustrates the storage system of FIG. 2 having a fault on the communication line thereof.

If any fault takes place between the switch 22 and the switch 23 in the storage system 10 as shown in FIG. 3, any communication line extending to the switch 23 becomes non-existent. The calculating devices 11 and 12 cannot access the HDDs 23a and 23b connected to the switch 23.

If any fault takes place between the switch 53 and the switch 55 in the storage system 40 as illustrated in FIG. 4, a remaining one communication line (a communication line between the switch 54 and the switch 56 in this case) is burdened with all communications performed by the faulty communication line. An increase in the communication traffic of the communication line reduces performance of the storage system 40.

If the remaining one communication line becomes faulty before the faulty communication line is restored, the HDD connected to the faulty communication line cannot be accessed in the same manner as in FIG. 3. Even if the communication line is duplicated, one line only communication is not preferable. For example, the HDD is preferably accessible from a different direction. A mere increase in the number of communication lines may overcome the above-described problem but is not acceptable from the standpoint of costs.

### SUMMARY

It is an object of the present technique to provide a storage system and a route switch for allowing a storage device to be accessed even in the event of a fault in a communication line connected to the storage device.

According to an aspect of an embodiment, a storage system includes a plurality of storage devices, each storage device housed in an enclosure thereof, and a route switch, connected to the storage devices, for controlling a frame exchanged between each enclosure and a calculating device, the enclosure being connected to at least two communication lines different in path from each other extending between the route switch and the enclosure. The route switch includes fault detecting means for detecting a fault on the communication line extending to the enclosure, table generating means for generating an address conversion table, the address conversion table mapping, based on the detection results of the fault detecting means, a first address indicating an address of a frame reaching the enclosure via a communication line free from the fault to a second address indicating an address of the frame reaching the enclosure prior to the occurrence of the fault, and frame control means for controlling the frame exchanged between the enclosure and the calculating device in accordance with the address conversion table.

### BRIEF DESCRIPTION OF THE DRAWING

FIG. 1 illustrates a known storage system;

FIG. 2 illustrates a known storage system having duplicated communication lines;

FIG. 3 illustrates a problem caused by a fault in a communication line of the storage system of FIG. 1; and

FIG. 4 illustrates a problem caused by a fault in a communication line of the storage system of FIG. 2.

FIG. 5 diagrammatically illustrates a storage system in accordance with a first embodiment of the present technique;

FIG. 6 diagrammatically illustrates the storage system in accordance with the first embodiment of the present technique;

FIG. 7 illustrates a data structure of a frame;

FIG. 8 is a functional block diagram illustrating a switch in accordance with the first embodiment of the present technique;

FIG. 9 is a functional block diagram illustrating a route switch in accordance with the first embodiment of the present technique;

FIG. 10 illustrates an address conversion table;

FIG. 11 illustrates the address conversion table with a fault taking place on a communication line;

FIG. 12 is a flowchart illustrating a process of the route switch in accordance with the first embodiment of the present technique;

FIG. 13 diagrammatically illustrates a storage system in accordance with a second embodiment of the present technique;

FIG. 14 diagrammatically illustrates the storage system in accordance with the second embodiment of the present technique;

FIG. 15 diagrammatically illustrates the storage system in accordance with the second embodiment of the present technique;

FIG. 16 is a functional block diagram of a device enclosure (DE) in accordance with the second embodiment of the present technique;

FIG. 17 is a functional block diagram of a route switch in accordance with the second embodiment of the present technique;

FIG. 18 is a flowchart illustrating a process of a communication performance monitoring process;

FIG. 19 illustrates a hardware structure of a computer forming the route switch of embodiments of the present technique;

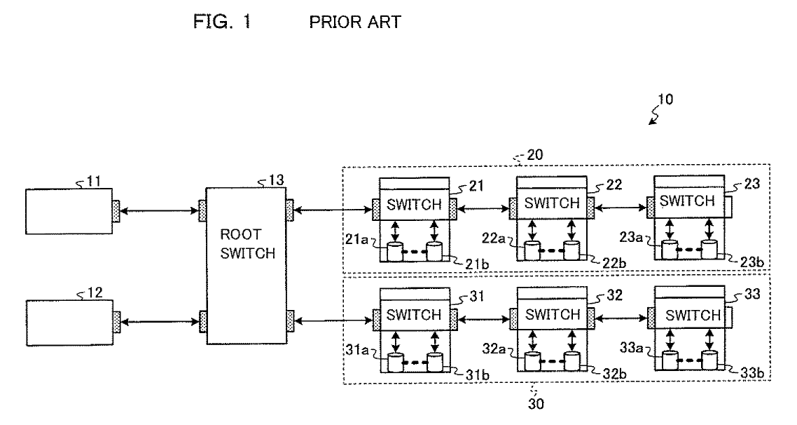

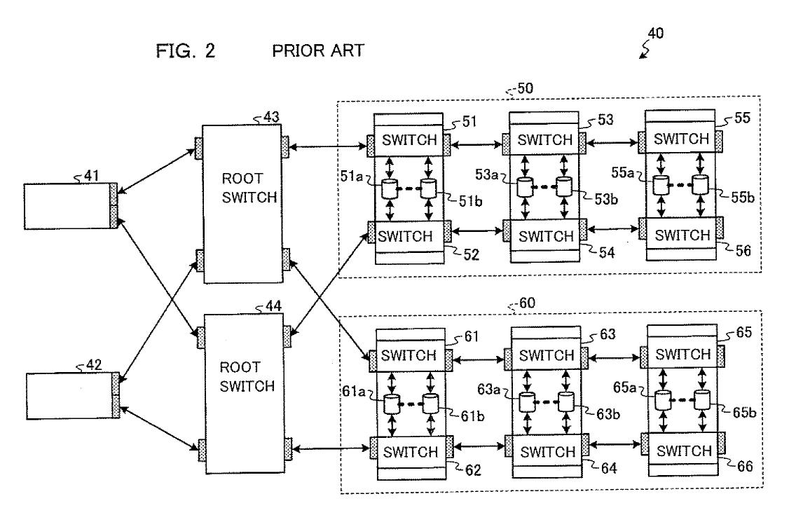

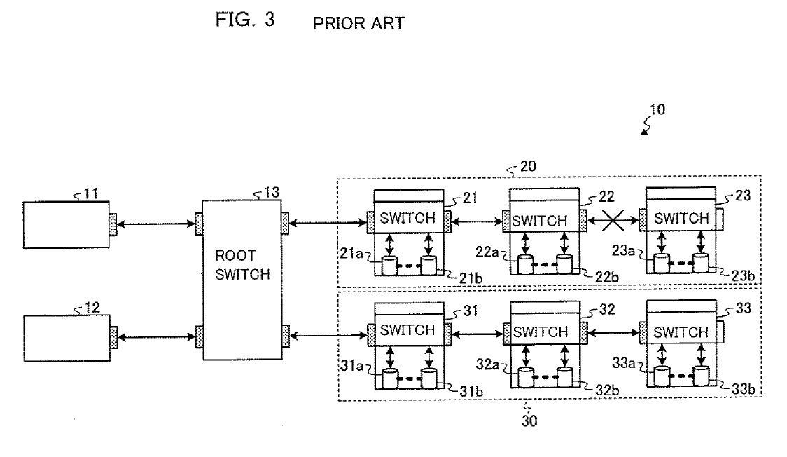

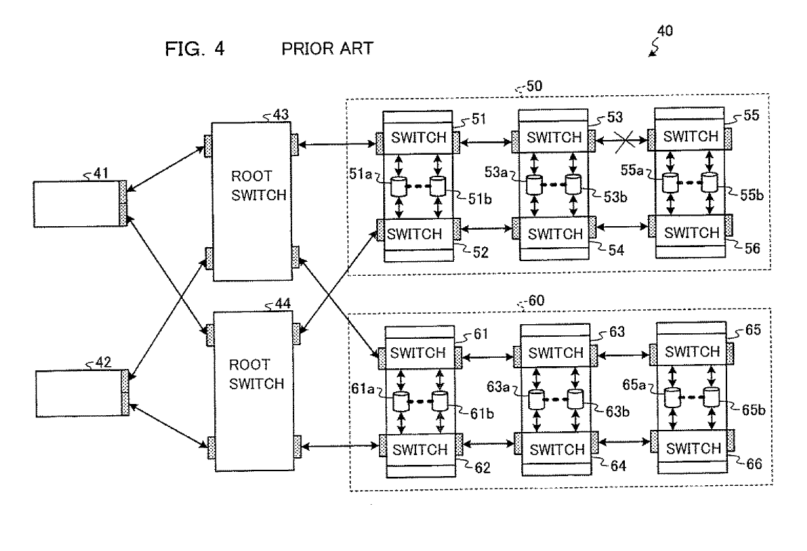

### DESCRIPTION OF THE PREFERRED EMBODIMENTS

A storage system and a route switch in accordance with the embodiments of the present technique are described below with reference to the accompanying drawings.

### First Embodiment

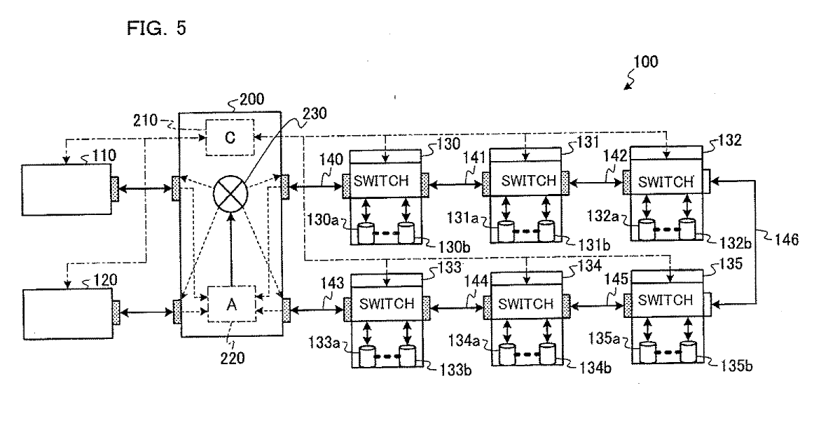

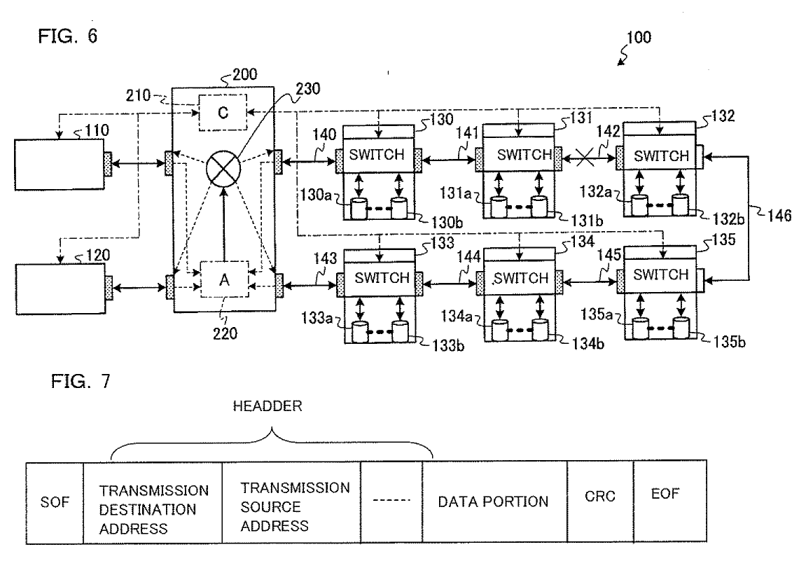

A storage system 100 of a first embodiment of the present technique is described below. FIGS. 5 and 6 diagrammatically illustrate the storage system 100. As illustrated in FIG. 5, the storage system 100 of the first embodiment of the present technique includes calculating devices 110 and 120, switches 130 through 135, communication lines 140 through 146, and a route switch 200. The switches 130 through 135 are respectively connected to hard disk drives (HDDs) 130a through 135a and HDDs 130b through 135b.

The calculating devices 110 and 120 perform a variety of processes by reading data from the HDDs connected to the switches 130 through 135. As switches in the related art, the switches 130 through 135 receives a frame and then outputs the received frame to a destination or an HDD connected thereto. Each of the switches 130 through 135 is connected to at least two communication lines different in path from each other between the route switch 200 and own switch (two communication lines in the configuration of FIG. 5).

More specifically, the switch 130 is connected to the communication lines 140 and 141, the switch 131 is connected to the communication lines 141 and 142, the switch 132 is connected to the communication lines 142 and 146, the switch 133 is connected to communication lines 143 and 144, the switch 134 is connected to the communication lines 144 and 145, and the switch 135 is connected to the communication lines 145 and 146.

The switches 130 through 135 periodically performs data communications with each other. If any of the switches 130 through 135 detects a fault in a communication line, the detecting switch outputs to the route switch 200 information indicating that the fault has occurred.

The route switch 200 is connected to each of the calculating devices 110 and 120 and the switches 130 and 133. Upon retrieving a frame from one of the calculating devices 110 and 120 and the switches 130 and 133, the route switch 200 transmits the frame to the destination thereof. The route switch 200 of the first embodiment of the present technique includes a manager 210, an address converter 220, and a router 230.

The manager 210 exchanges control information between each of the calculating devices 110 and 120 and each of the switches 130 through 135, thereby controlling ports of the calculating devices 110 and 120 and the switches 130 through 135. For example, if a fault occurs on the communication line 142 as illustrated in FIG. 6 (if information that the fault has occurred on the communication line 142 has been received from the switches 131 and 132), the ports of the switches 131 and 132 connected to the communication line 142 are switched off, and ports of the switches 132 and 135 connected to the communication line 146 are switched on.

In the event of a fault on the communication line, the address converter 220 converts an address of a frame addressed to a switch, connected to and present beyond the faulty communication line, into an address that permits the frame to reach that switch via a communication line free from the fault.

A fault may now occur on the communication line 142 as illustrated in FIG. 6.

The address converter 220 receives a frame addressed to the switch 132 from the calculating device 110. The address converter 220 converts the address of the frame into an address so that the frame reaches the switch 132 via the communication lines 143, 144, 145 and 146. Upon receiving a frame response responsive to the frame from the switch 132, the address converter 220 converts back the address of the transmission source of the received frame into the original address prior to address conversion.

The router 230 outputs the frame to a destination in accordance with the address of the frame destination. The storage system 100 of the first embodiment of the present technique switches ports in response to the occurrence of the fault and converts the address of the destination. In the event of the fault on the communication line, the router 230 can still access the HDD connected to and present beyond the faulty communication line.

If the frame response is received from the HDD subsequent to the address conversion, the route switch 200 converts the address of the frame transmission source back into the address prior to the address conversion. This arrangement eliminates the need for the calculating devices 110 and 120 to perform any particular process and thus copes with the communication line fault.

A data structure of the frame exchanged in the storage system 100 is described below. FIG. 7 illustrates an example of the data structure of the frame. As illustrated in FIG. 7, the frame includes a start of frame (SOF) portion indicating a start of the frame, a header containing a transmission destination address and a transmission source address, a data portion containing a variety of data, a cyclic redundancy check (CRC) portion indicating a protective check code of frame data, and an end of frame (EOF) portion indicating an end of the frame.

Each address (transmission destination address and transmission source address) contains information (fibre channel addresses) identifying each device (calculating devices 110 and 120, the switches 130 through 135, and the route switch 200). Each fibre channel address having a size of 24 bits contains a domain address of 8 bits, an area address of 8 bits, and a port address of 8 bits. More specifically, the fibre channel address (24 bits)=domain address (8 bits)+area address (8 bits)+port address (8 bits).

Each switch is assigned a domain address and a port of the switch is assigned an area address. The port address is an arbitrated loop physical address (ALPA). Referring to FIG. 6, there are shown a first port address and a second port address. The first port address causes a frame to be transmitted in a loop of the communication lines 140, 141, 142, 146, 145, 144 and 143 in that order, and the second port address causes a frame to be transmitted in a loop of the communication lines 143, 144, 145, 146, 142, 141, and 140 in that order. More specifically, by modifying the area address and the port address of the addresses, the communication line extending to the addressed switch is modified as described with reference to FIG. 6.

The area address of the transmission destination addresses of the frame to be transmitted to the switch 132 may now indicate a port number connected the communication line 140, and the port address may now be set to the first port address. If a fault occurs on the communication line 142, the route switch 200 modifies the area address of the transmission destination addresses of the frame to be transmitted to the switch 132 to the port number connected to the communication line 143, and then modifies the port address to the second port address.

When the route switch 200 modifies the transmission destination addresses in this way, the frame addressed to the switch 132 reaches the switch 132 via the communication lines 143, 144, 145, and 146. In other words, the frame does not pass through the communication line 142.

One of HDDs (HDDs 130a through 135a, and HDDs 130b through 135b) having received a frame from one of the calculating devices 110 and 120 generates a transmission destination address for a frame response based on the transmission destination address of the received frame. For example, the HDD 132a may now receive a frame. The HDD 132a determines a loop direction of the received frame by referencing the port address of the transmission destination address of the received frame.

If the port address is the first port address, the HDD 132a determines that the frame has been received via the communication line 142. If the port address is the second port address, the HDD 132a determines that the frame has been received via the communication line 146.

If the port address of the received frame is the first port address, the HDD 132a sets, as the transmission destination addresses of the frame response, the address of the port connected to the communication line 142 for the area address, the second port address for the port address, and the domain address of one of the calculating device 110 and the calculating device 120 (the domain address of a transmission source address contained in the received frame) for the destination domain address. The HDD 132a then transmits the set addresses to the switch 132.

If the port address of the received frame is the second port address, the HDD 132a sets, as the transmission destination addresses of the frame response, the address of the port connected to the communication line 146 for the area address, the first port address for the port address, the domain address of one of the calculating device 110 and the calculating device 120 (the domain address of a transmission source address contained in the received frame) for the destination domain address. The HDD 132a then transmits the set addresses to the switch 132.

In response the fault on the communication line, the route switch 200 modifies the transmission destination addresses of the frame, and each of the HDDs 130a through 135a, and HDDs 130b through 135b modifies the transmission destination addresses of the frame response based on the port address of the frame transmitted from the route switch 200. In the event of the fault, the switches 130 through 135 simply transmit the frame in response to the transmission destination addresses of the frame as usual. Without performing any particular process, the storage system 100 correctly performs data communications.

The structure of the switches 130 through 135 of FIG. 5 is described below. Since the switches 130 through 135 are identical in structure to each other, only the switch 130 is discussed herein and the discussion of the structure of the remaining switches 131 through 135 is omitted.

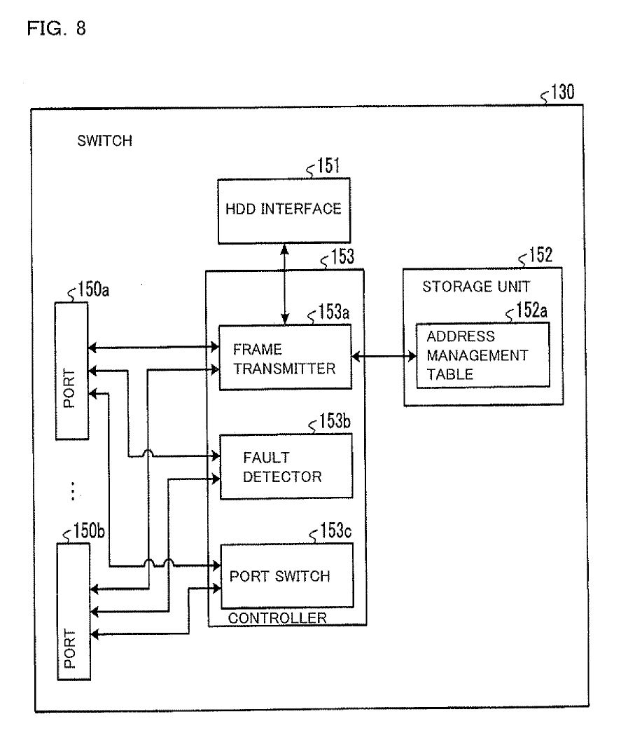

FIG. 8 is a functional block diagram of the switch 130 of the first embodiment of the present technique. The switch 130 includes ports 150a and 150b, an HDD interface 151, a storage unit 152, and a controller 153.

The ports 150a and 150b are used to connect electrically the switch 130 to communication lines (not shown). Only the ports 150a and 150b are shown in FIG. 8 for convenience of explanation, but the switch 130 may include more ports. The HDD interface 151 processes data communications with the HDDs 130a and 130b connected to the switch 130.

The storage unit 152 stores data and programs the controller 153 needs to perform a variety of processes. In particular, the storage unit 152 stores an address management table 152a closely related to the present technique. The storage unit 152 stores the transmission destination addresses (including the domain address, the area address, and the port address) contained in the frame, and one of identification information of a port corresponding to the transmission destination addresses and identification information of the HDD (connected to the switch 130) with the transmission destination address mapped to the identification information.

The controller 153, including an internal memory for storing control data and a program defining a variety of processes, performs the variety of processes. The controller 153 includes, as elements particularly closely related to the present technique, a frame transmitter 153a, a fault detector 153b, and a port switch 153c.

Upon receiving a frame from one of the ports 150a and 150b and the HDD interface 151, the frame transmitter 153a compares the transmission destination address of the received frame with the address management table 152a, and then outputs the frame to one of the ports 150a and 150b and the HDD interface 151 responsive to the transmission destination address.

The fault detector 153b detects a fault on a communication line by performing periodically data communications with another device. Any of known techniques may be used for fault detection. For example, a test frame is transmitted to another device, and determines that an fault has occurred on the communication line extending to the other device if no response is returned from the other device within a predetermined period of time. If a communication line fault is detected, the fault detector 153b outputs to the route switch 200 information related to the communication line suffering from the fault (for example, information identifying the communication line suffering from the fault).

The port switch 153c switches ports of the switch 130 in response to port switching information transmitted from the route switch 200. For example, if the port switching information to switch on the port 150a and to switch off the port 150b is received, the port switch 153c switches on the port 150a and switches off the port 150b in accordance with the port switching information.

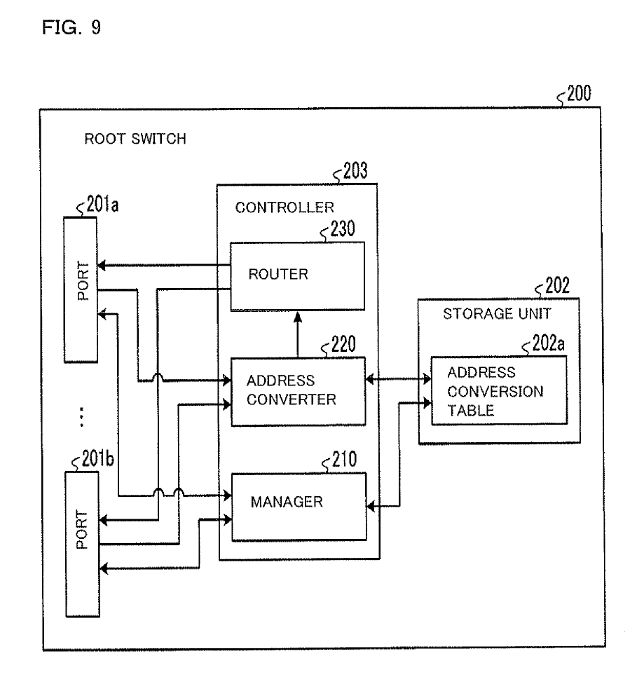

The structure of the route switch 200 of FIG. 5 is described below. FIG. 9 is a functional block diagram illustrating the route switch 200 in accordance with the first embodiment of the present technique. As illustrated in FIG. 9, the route switch 200 includes ports 201a and 201b, a storage unit 202, and a controller 203.

The ports 201a and 201b are used to connect electrically the route switch 200 with communication lines (not shown). Although only the ports 201a and 201b are shown in FIG. 9 for convenience of explanation, more ports may be included in the route switch 200.

The storage unit 202 stores data and programs that the controller 203 needs to perform a variety of processes. The storage unit 202 stores an address conversion table 202a which is closely related to the present technique. The address conversion table 202a is used to modify a path (address) of the frame to be transmitted to a destination.

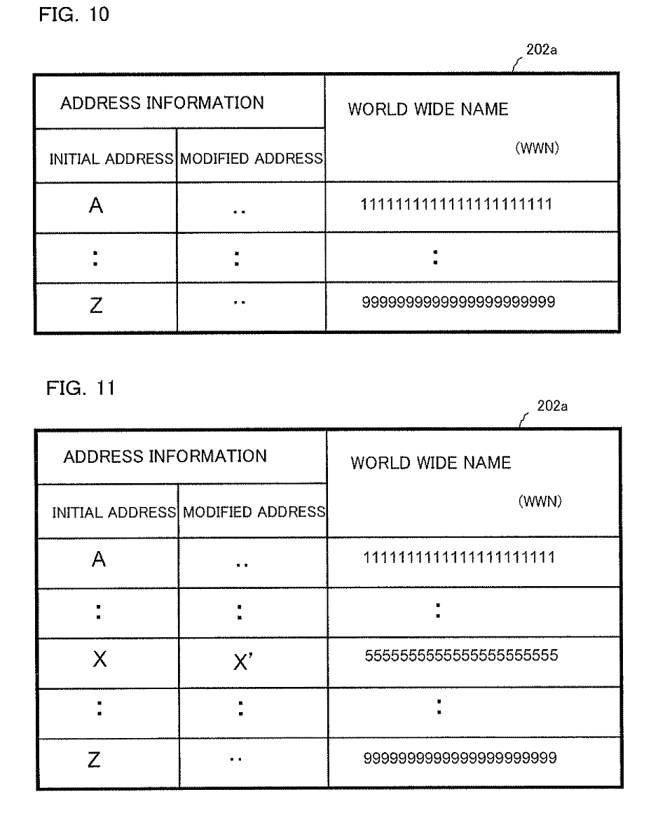

FIG. 10 illustrates the address conversion table 202a. As illustrated in FIG. 10, the address conversion table 202a includes address information of a transmission destination or a transmission source, and world wide name (WWN) identifying the devices (the calculating devices 110 and 120, the switches 130 through 135, the HDDs 130a through 135a, and HDDs 130b through 135b) with the address information mapped to the WWN.

The address information includes initial addresses (domain address, area address, and port address) and modified addresses (domain address, area address, and port address). The initial addresses are those assigned to devices when the storage system 100 starts up. The modified addresses are those at which the frame reaches the intended device via a communication line instead of the communication lines currently used (including the communication line suffering from the fault) when the fault occurs on the communication line currently used.

The controller 203, including an internal memory for storing data and a program defining a variety of processes, performs the variety of processes. In particular, the controller 203 includes, as elements particularly related to the present technique, the manager 210, the address converter 220, and the router 230.

The manager 210 exchanges control information between one of the calculating devices 110 and 120 and one of the switches 130 through 135, thereby controlling the ports of the calculating devices 110 and 120 and the switches 130 through 135. If the fault is detected on the communication line 142 as shown in FIG. 6 (if information that the fault has occurred on the communication line 142 has been received from the switches 131 and 132), the manager 210 outputs port switching information. The manager 210 thus switches off the ports of the switches 131 and 132 connected to the communication line 142 while switching on the ports of the switches 132 and 135 connected to the communication line 146.

In the case of the fault on the communication line, the manager 210 generates a modified address corresponding to the initial address in the address conversion table 202a and then stores the modified address in the address conversion table 202a. FIG. 11 illustrates the address conversion table 202a registered in the event of the fault.

The process of the manager 210 is described below with reference to FIGS. 6 and 11. Device unique information of the switch 132 may be “5555 . . . ” and the initial address may be X. If the fault occurs on the communication line 142, a modified address X′ is generated, and registered in the address conversion table 202a.

The initial address X is an address that allows the frame to reach the switch 132 via the communication lines 140 through 142. More specifically, the address of the port connected to the communication line 140 is set to the area address, the first port address is set to the port address, and the number assigned to the switch 132 (or the HDD under the switch 132) is assigned to the domain address. The modified address X′ is an address that allows the frame to reach the switch 132 via the communication lines 143 through 146. More specifically, the address of the port connected to the communication line 143 is set to the area address, the second port address is set to the port address, and the number assigned to the switch 132 (or the HDD under the switch 132) is assigned to the domain address.

A method of the manager 210 for generating the modified address is not limited to any particular one. For example, communication lines that can be faulty, information identifying switches, and modified addresses may be pre-registered in a table in a form with one piece of information mapped to another. In the case of a fault on a communication line, the table is compared with the faulty communication line and the information identifying the switches to identify the modified address. The modified address is thus generated.

The address converter 220 converts one of the transmission destination address and the transmission source address of the frame in accordance with the address conversion table 202a. In the discussion that follows, the process of the address converter 220 is divided into a process performed when the frame is received from one of the calculating devices 110 and 120 and a process performed when the frame is received from one of the switches 130 through 135.

(Frame Received from the Calculating Device Side)

The address converter 220 compares the transmission destination address of the frame with the address conversion table 202a and then determines whether a modified address is present in the initial addresses responsive to the transmission destination address. If it is determined that the modified address is present, the address converter 220 changes the transmission destination address to the modified address. If it is determined that the modified address is not present, the transmission destination address is not modified.

If the transmission destination address is “A”, any modified address corresponding to the initial address “A” is not present, and the transmission destination address remains to be “A” (see FIG. 11).

If the transmission destination address is X, the modified address X′ corresponding to the initial address X is present, and the transmission destination address is changed to X′.

(Frame Received from the Switch Side)

The address converter 220 compares the transmission source address of the frame with the address conversion table 202a and then determines whether the modified address corresponding to the transmission source address is present in the address conversion table 202a. If it is determined that the modified address corresponding to the transmission source address is present, the transmission source address is modified to the initial address corresponding to the modified address. If it is determined that any modified address corresponding to the transmission source address is not present, the transmission source address is not modified.

If the transmission source address is “A”, any modified address corresponding to the transmission source address “A” is not present, and the transmission source address remains to be “A” (see FIG. 11). If the transmission source address is X′, the modified address X′ is present, and the transmission destination address is changed to the initial address X.

The address converter 220 outputs to the router 230 the frame having undergone the address conversion process. Upon receiving the frame from the address converter 220, the router 230 outputs the frame to the destination in accordance with the address of the frame transmission destination.

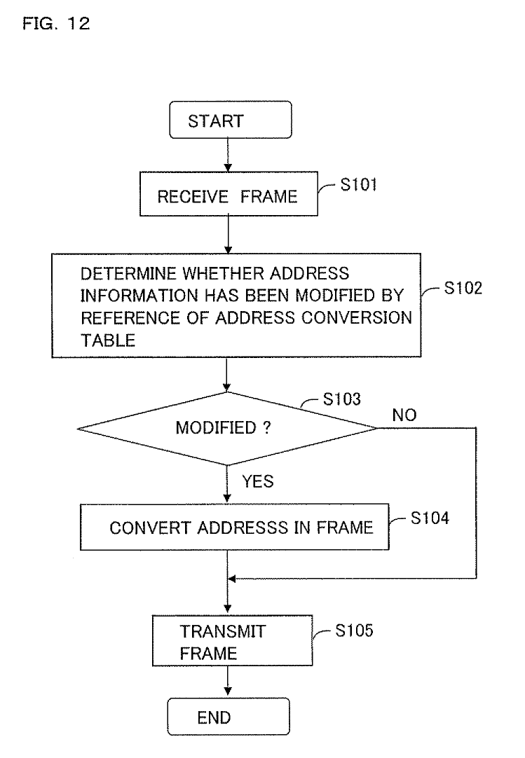

The process of the route switch 200 in accordance with the first embodiment of the present technique is described below. FIG. 12 is a flowchart illustrating the process of the route switch 200 of the first embodiment. As illustrated in FIG. 12, the route switch 200 receives the frame (step S101), references the address conversion table 202a and determines whether the address information has been modified (step S102).

If it is determined in step S103 that the address information has been modified, the route switch 200 converts the address in the frame (step S104) and transmits the frame (step S105). If it is determined in step S103 that the address information has not been modified, the route switch 200 proceeds to step S105.

The route switch 200 modifies the address of the frame (the transmission destination address or the transmission source address) in accordance with the address conversion table 202a. Even if a fault occurs on a communication line, the route switch 200 can still access the HDD connected to and present beyond the communication line suffering from the fault.

As described above, in the storage system 100 of the first embodiment, each of the switches 130 through 135 is connected to at least two communication lines different in path between the route switch 200 and each of the switches 130 through 135. If a fault is detected at any communication line extending to any of the switches 130 through 135, the route switch 200 converts the transmission destination address of the frame to the modified address, and thus controls the frame exchanged between one of the calculating devices 110 and 120 and one of the switches 130 through 135. In the event of the fault on the communication line, each of the calculating devices 110 and 120 can still access the HDD connected to and present beyond the communication line suffering from the fault.

When the frame response is received from the HDD subsequent to the address conversion process, the route switch 200 converts the address of the transmission source address of the frame into the address prior to the address conversion process. The storage system 100 can thus cope with the communication line fault without causing the calculating devices 110 and 120 to perform any particular process.

### Second Embodiment

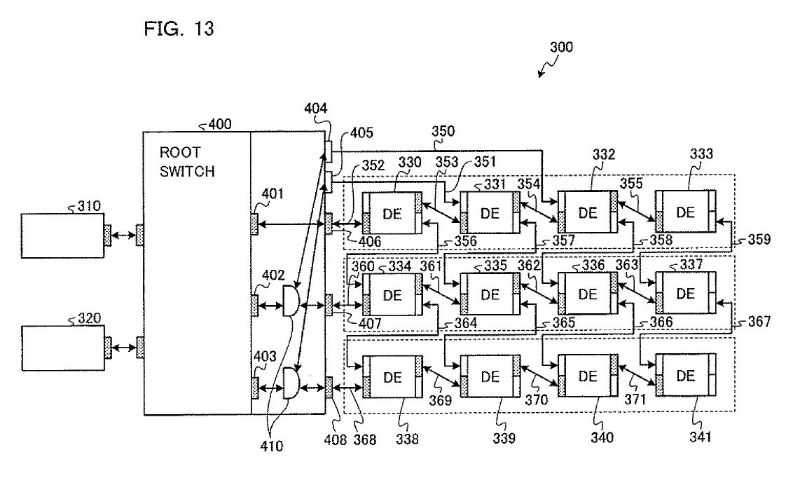

A storage system 300 of a second embodiment of the present technique is described below. FIGS. 13 through 15 diagrammatically illustrates the storage system 300 of the second embodiment of the present technique. As illustrated in FIG. 13, the storage system 300 of the second embodiment includes calculating devices 310 and 320, device enclosures (DEs) 330 through 341, and a route switch 400.

The calculating devices 310 and 320 read data from the DEs 330 through 341 connected to the route switch 400, and perform a variety of processes. Each of the DEs 330 through 341 includes a plurality of HDDs, and at least four ports for external connection.

The route switch 400, including port switch multiplexers 401 for increasing the number of ports, is connected to each of the calculating devices 310 and 320 and the DEs 330 through 341. Upon receiving a frame from each of the calculating devices 310 and 320 and the DEs 330 through 341, the route switch 400 outputs the received frame to the destination.

The route switch 400 of the second embodiment of the present technique monitors communication performance of each of the ports 401 through 403 thereof. If a drop in communication performance detected, the route switch 400 performs a communication path diversion process to compensate for the drop. In the communication path diversion process, the route switch 400 diverts the access path between each of the calculating devices 310 and 320 and each of the DEs 330 through 341. The causes of the performance drop can be that a plurality of calculating devices access a single communication line or that the number of DEs (number of cascades) connected to one port of the route switch 400 is too many.

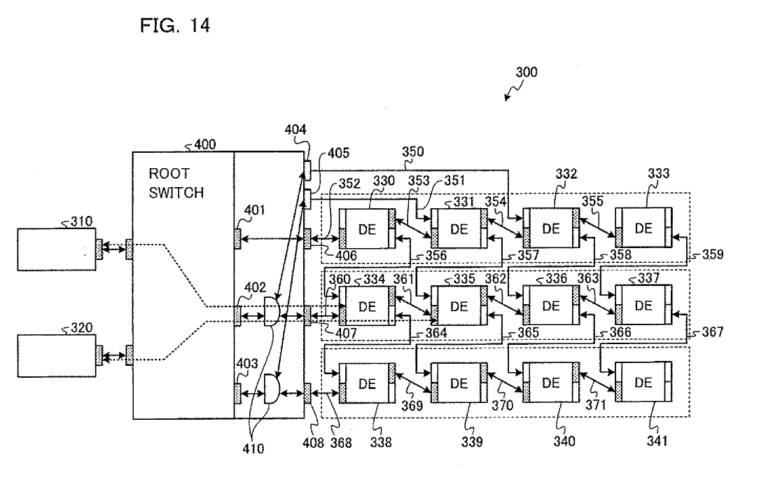

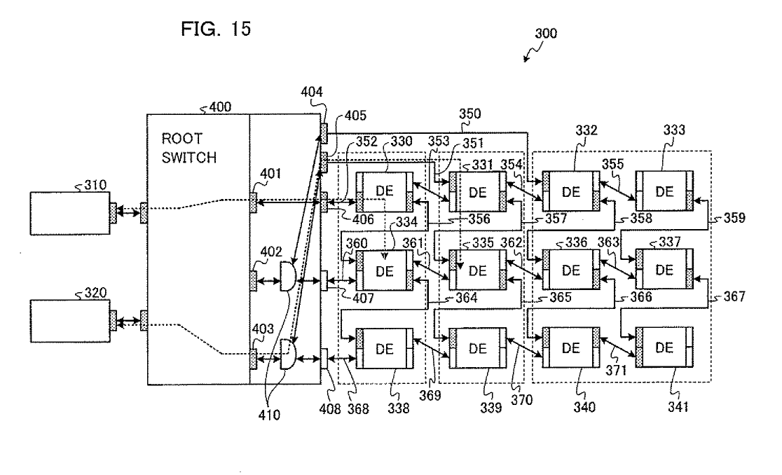

As illustrated in FIG. 14, the number of accesses of the calculating device 310 to the HDDs in the DE 334 may be above a predetermined value, the number of accesses of the calculating device 320 to the DE 335 may be above a predetermined value, and the utilization of the port 402 may be high. In such a case, the path control of FIG. 15 is performed. More specifically, the route switch 400 converts the transmission destination address of the frame so that the path from the calculating device 310 to the DE 334 is changed to cause the frame to reach the DE 334 via the ports 401, 406, and the DE 330.

The route switch 400 also converts the transmission destination address of the frame so that the path from the calculating device 320 to the DE 335 is changed to cause the frame to reach the DE 335 via the ports 403, 405, and the DEs 330 and 331. The port 404 unused in FIG. 13 is switched on, thereby increasing communication performance of the port 402.

In the case of a performance drop, the storage system 300 of the second embodiment of the present technique controls the communication line of the frame in order to diverge accessing currently concentrated on one port. The communication performance drop of a particular port is thus controlled and performance of the storage system 300 is increased.

The DEs 330 through 341 illustrated in FIG. 13 and other drawings are described below. Since the DEs 330 through 341 are identical in structure to each other, only the DE 330 is discussed instead of discussing all the DEs 330 through 341.

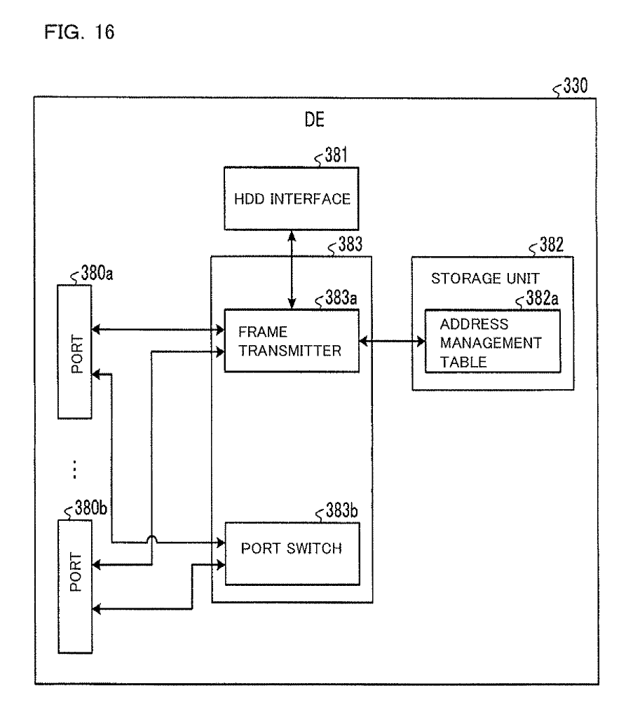

FIG. 16 is a functional block diagram of the DE 330 of the second embodiment of the present technique. As illustrated in FIG. 16, the DE 330 includes ports 380a and 380b, an HDD interface 381, a storage unit 382, and a controller 383.

The ports 380a and 380b are used to connect electrically the DE 330 to communication lines (not shown). For convenience of explanation, only the ports 380a and 380b are shown, but the use of more ports is perfectly acceptable (the DE 330 has herein four ports). The HDD interface 381 performs data communications with the HDD connected to the DE 330.

The storage unit 382 stores data and program the controller 383 needs to execute a variety of processes. In particular, the storage unit 382 stores an address management table 382a closely related to the present technique. The address management table 382a holds the transmission destination addresses contained in the frame, and one of identification information of a port corresponding to the transmission destination addresses and identification information of the HDD (connected to the DE 330) with the transmission destination address mapped to the identification information.

The controller 383, including an internal memory for storing control data and a program defining a variety of processes, performs the variety of processes. The controller 153 includes, as elements particularly closely related to the present technique, a frame transmitter 383a, and a port switch 383b.

Upon receiving a frame from one of the ports 380a and 380b and the HDD interface 381, the frame transmitter 383a compares the transmission destination address of the received frame with the address management table 382a, and then outputs the frame to one of the ports 380a and 380b and the HDD interface 381 responsive to the transmission destination address.

The port switch 383b switches ports of the DE 330 in response to port switching information transmitted from the route switch 400. For example, if the port switching information to switch on the port 380a and to switch off the port 380b is received, the port switch 383b switches on the port 380a and switches off the port 380b in accordance with the port switching information.

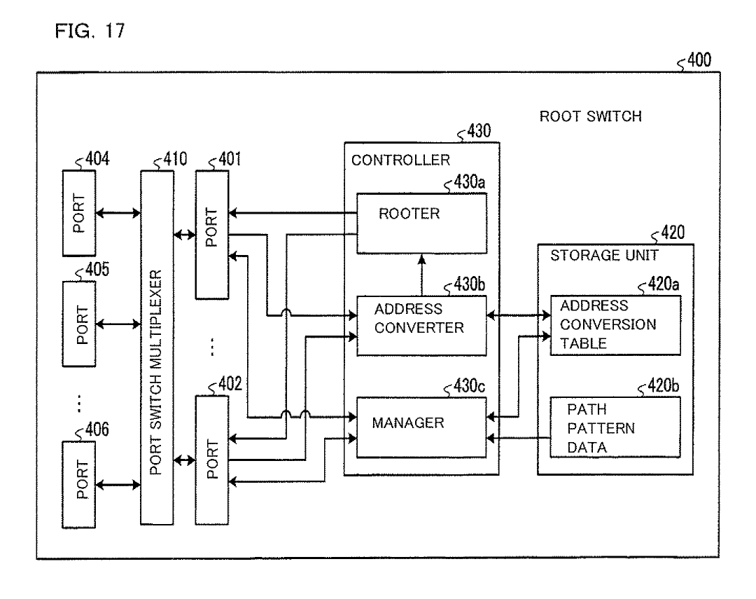

The structure of the route switch 400 of FIG. 13 and other drawings is described below. FIG. 17 is a functional block diagram illustrating the route switch 400 in accordance with the second embodiment of the present technique. As illustrated in FIG. 17, the route switch 400 includes ports 401 through 406, a port switch multiplexer 410, a storage unit 420, and a controller 430.

The ports 401 through 406 are used to connect electrically the route switch 400 with communication lines (not shown). Although only the ports 401 through 406 are shown in FIG. 17 for convenience of explanation, more ports may be included in the route switch 400.

Upon receiving the frame from the ports 401 and 402, the port switch multiplexer 410 assigns the received frame to one of the ports 404 through 406 in accordance with the transmission destination address of the received frame. The port switch multiplexer 410 outputs the frame received from one of the ports 404 through 406 to one of the ports 401 and 402.

The storage unit 420 stores data and program the controller 430 needs to perform a variety processes. In particularly, the storage unit 420 stores an address conversion table 420a and path pattern data 420b, closely related to the present technique.

When communication performance of a predetermined port drops, the address conversion table 420a is used to modify the path (address) of the frame to be transmitted to a destination. A data structure of the address conversion table 420a is identical to the data structure of the address conversion table 420a of FIG. 10, and the discussion thereof is omitted herein.

The path pattern data 420b stores identification information of each port, identification information (or a transmission source address) of a calculating device serving as a transmission source, identification information (or a transmission destination address) of the DE as a destination, and an address modified when the communication performance of the port drops. The path pattern data 420b holds those pieces of information one piece mapped to each other.

The controller 430, including an internal memory storing control data and a program defining a variety of processes, and executes the variety of processes. The controller 430 includes, as elements closely related to the present technique, a router 430a, an address converter 430b, and a manager 430c.

The router 430a receives a frame from the address converter 430b, and outputs to the frame to a destination in accordance with an address serving as the destination of the frame.

The address converter 430b converts one of a transmission destination address of the frame and a transmission source address of the frame in accordance with the address conversion table 420a. In the discussion that follows, the process of the address converter 430b is divided into a process performed when the frame is received from one of the calculating devices 310 and 320 and a process performed when the frame is received from one of the DEs 330 through 341.

(Frame Received from the Calculating Device Side)

The address converter 430b compares the transmission destination address of the frame with the address conversion table 420a and then determines whether a modified address is present in the initial addresses responsive to the transmission destination address. If it is determined that the modified address is present, the address converter 430b changes the transmission destination address to the modified address. If it is determined that the modified address is not present, the transmission destination address is not modified.

If the transmission destination address is “A”, any modified address corresponding to the initial address “A” is not present, and the transmission destination address remains to be “A” (see FIG. 11).

If the transmission destination address is X, the modified address X′ corresponding to the initial address X is present, and the transmission destination address is changed to X′.

(Frame Received from the DE Side)

The address converter 430b compares the transmission source address of the frame with the address conversion table 420a and then determines whether the modified address corresponding to the transmission source address is present in the address conversion table 420a. If it is determined that the modified address corresponding to the transmission source address is present, the transmission source address is modified to the initial address corresponding to the modified address. If it is determined that any modified address corresponding to the transmission source address is not present, the transmission source address is not modified.

If the transmission source address is “A”, any modified address corresponding to the transmission source address “A” is not present, and the transmission source address remains to be “A” (see FIG. 11). If the transmission source address is X′, the modified address X′ is present, and the transmission source address is changed to the initial address X.

The manager 430c performs a port switching process and port communication performance monitoring process. In the port switching process, the manager 430c exchanges control information between one of the calculating devices 310 and 320 and one of the DEs 330 through 341, thereby controlling ports of the calculating devices 310 and 320 and the DEs 330 through 341. In the port communication performance monitoring process, the manager 430c monitors communication performance of each port.

### Port Switching Process

If the port 402 suffers from a drop in communication performance as previously discussed with reference to FIGS. 13 through 15, the manager 430c outputs port switching information to the DEs 330 through 341. The controller 430 thus switches on and off the DEs 330 through 341.

In the example of FIGS. 13 through 15, the manager 430c switches off the port of the DE 330 connected to the communication line 353, and switches on the port of the DE 330 connected to the communication line 356. The discussion of switch on/off of the ports of the remaining DEs 331 through 341 is omitted here. Each port switched on is shaded, and each port switched off is blanked prior to outputting of the port switching information as illustrated in FIG. 14, and each port switched on is shaded, and each port switched off is blanked subsequent to outputting of the port switching information as illustrated in FIG. 15.

### Communication Performance Monitoring Process

The manager 430c monitors communication performance of the ports 401 through 403 of the route switch 400. If a communication performance is detected, the manager 430c compares the identification information of the port suffering a communication performance drop with the path pattern data 420b. The manager 430c thus determines the initial address to be modified, and a modified address corresponding to the initial address, and then updates the address conversion table 420a with the determined modified address.

If the port 402 drops in communication performance, the manager 430c sets a modified address to reach the DE 334 via the ports 401 and 406 and the DE 330, replacing the initial address of the frame output from the calculating device 310 to the DE 334 (the address to reach the DE 334 via the ports 402 and 407).

The manager 430c thus monitors the communication performance monitoring process in this way. Any known technique may be used for the manager 430c. For example, the manager 430c may receive port statistic information, device connection information, etc. of the route switch 400. If communication traffic passing through a port becomes higher than a threshold value, the manager 430c determines that that port drops in communication performance.

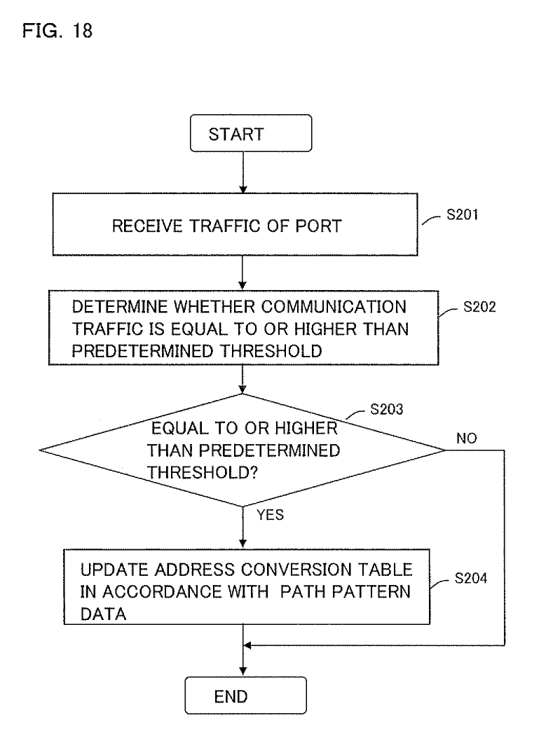

The communication performance monitoring process of the manager 430c of the second embodiment is described below. FIG. 18 is a flowchart illustrating the communication performance monitoring process. As illustrated in FIG. 18, the manager 430c receives traffic of each port (step S201) and then determines whether the communication traffic is equal to or higher than a predetermined threshold (step S202).

If it is determined in step S203 that the communication traffic is equal to or higher than the predetermined threshold, the manager 430c updates the address conversion table 420a in accordance with the path pattern data 420b (step S204). If it is determined in step S203 that the communication traffic is lower than the predetermined threshold, the communication performance monitoring process ends. The process of FIG. 18 is periodically performed.

In the storage system 300 of the second embodiment of the present technique, the route switch 400 monitors communication performance of each port. If a port communication performance drop is detected, the route switch 400 performs path control by diverging the access path from the calculating devices 310 and 320 to the DEs 330 through 341 in order to avoid performance drop. Communication performance drop at any port is controlled, and performance of the storage system 300 is thus increased.

In accordance with the second embodiment of the present technique, the manager 430c produces the path pattern data 420b in advance. The controller 430 then determines the modified address corresponding to the initial address based on the path pattern data 420b. The present technique is not limited to this method. For example, the manager 430c may periodically identify an optimum path from among path patterns the frame can take, and updates the path pattern data 420b as appropriate in accordance with the identified path.

A low utilization DE may be detected from the transmission destination address of the transmitted frame, and path control may be performed so that a higher number of these DE may be cascaded (to a predetermined number of stages or more), and so that a lower number of high utilization DEs is cascaded (to less than the predetermined number of stages). Communication performance is thus increased.

Part or whole of each process discussed as the one to be automatically executed in connection with each embodiment may be manually performed. On the contrary, part or whole of each process discussed as the one to be manually executed in connection with each embodiment may be automatically performed in a known method. The process flow, the control process, specific names, and information containing a variety of data and parameters discussed in the specification and illustrated in the drawings may be modified unless otherwise specifically noted.

Elements, such as route switches (FIGS. 9 and 17), switches (FIG. 8), and DEs (FIG. 16), contained in the storage systems 100 and 300 shown in FIGS. 5 and 13, represent functional concepts and do not necessarily mean that the system is physically configured as illustrated. More specifically, the specific distributed or integrated configuration of each apparatus is not limited to the one illustrated, and part or whole of the apparatus may be distributed or integrated functionally or physically by any unit depending on various workloads and operational status. Any part or whole of a process function performed by each apparatus may be performed by a CPU or a program analyzed and executed by the CPU, or may be performed by wired logic hardware.

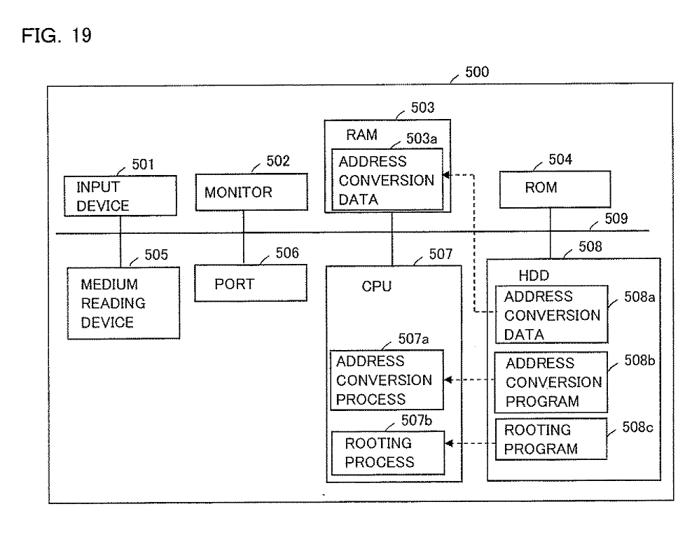

FIG. 19 illustrates a hardware structure of a computer forming the route switch of the above-referenced embodiments. As illustrated in FIG. 19, a computer (route switch) 500 includes an input device 501 for receiving a variety of data, a monitor 502, a random-access memory (RAM) 503, a read-only memory (ROM) 504, a medium reading device 505 for reading data from a recording medium, a port 506 for exchanging data with another device, a central processing unit (CPU) 507, a hard disk drive (HDD) 508, and a bus 509 interconnecting those elements.

The HDD 508 stores an address conversion program 508b and a routing program 508c, performing the same function as the route switches 200 and 400. The CPU 507 reads and executes the address conversion program 508b and the routing program 508c, thereby starting up an address conversion process 507a and a routing process 507b. The address conversion process 507a corresponds to the address converters 220 and 430b and the routers 230 and 430a in FIGS. 9 and 17, and the routing process 507b corresponds to the managers 210 and 430c in FIGS. 9 and 17.

The HDD 508 stores address conversion data 508a. The address conversion data 508a corresponds to the address conversion table 202a of FIG. 9. The CPU 507 reads the address conversion data 508a from the HDD 508 and stores the address conversion data 508a onto the RAM 503. The CPU 507 executes the path control process of the storage system using address conversion data 503a stored on the RAM 503.

The address conversion program 508b and the routing program 508c shown in FIG. 19 are not necessarily stored on the HDD 508 from the start. For example, the address conversion program 508b and the routing program 508c are stored on a “portable physical recording medium” to be loaded onto the computer, a “fixed physical recording medium” arranged internal or external to the computer, and another “computer or server” to be connected to a host computer via a public telephone line, the Internet, a local-area network (LAN), or a wide-area network (WAN). The portable physical recording media may include a flexible disk (FD), a compact-disk read-only memory (CD-ROM), a digital versatile disk (DVD), a magneto-optical disk, and an IC card. The fixed physical recording media include a hard disk drive. The host computer reads the address conversion program 508b and the routing program 508c from one of these media and executes the programs.

What is claimed is:

1. A storage system comprising:
a calculating device;
a plurality of storage devices, each storage device housed in an enclosure; and
a route switch, connected to the storage devices, for controlling a frame exchanged between the enclosure and the calculating device, the enclosure being connected to at least two communication lines different in path from each other extending between the route switch and the enclosure,
the route switch including
fault detecting means for detecting a fault on the communication line extending to the enclosure,
table generating means for generating an address conversion table, the address conversion table mapping, based on the detection results of the fault detecting means, a first address indicating an address of a frame reaching the enclosure via a communication line free from the fault to a second address indicating an address of the frame reaching the enclosure prior to the occurrence of the fault, and
frame control means for controlling the frame exchanged between the enclosure and the calculating device in accordance with the address conversion table.

2. The storage system according to claim 1, wherein the frame control means converts the second address into the first address by comparing the second address serving as a transmission destination of the frame with the address conversion table if the frame is received from the calculating device, and outputs to the transmission destination the frame having the converted address.

3. The storage system according to claims 2, wherein the frame control means converts the first address into the second address by comparing the first address serving as a transmission source of the frame with the address conversion table if the frame is received from the storage device, and outputs to the transmission destination the frame having the converted address.

4. The storage system according to claims 1, wherein the frame control means converts the first address into the second address by comparing the first address serving as a transmission source of the frame with the address conversion table if the frame is received from the storage device, and outputs to the transmission destination the frame having the converted address.

5. The storage system according to claim 1, further including communication performance monitoring means for monitoring a drop in communication performance of the communication line extending to the storage device, and modification table generating means for generating an address modification table, the address modification table mapping the second address to a third address, to which the address of the frame is modified so that the path of the communication line of the frame reaching the storage device is diverged, wherein the frame control means controls the frame exchanged between the storage device and the calculating device in accordance with the address modification table.

6. A route switch, connected to a plurality of devices, each device performing a predetermined process, for controlling a frame exchanged between each of the devices and a calculating device, the route switch comprising:
fault detecting means for detecting a fault on a communication line extending to the enclosure;
table generating means for generating an address conversion table, the address conversion table mapping, based on the detection results of the fault detecting means, a first address indicating an address of a frame reaching the enclosure via a communication line free from the fault to a second address indicating an address of the frame reaching the enclosure prior to the occurrence of the fault; and
frame control means for controlling the frame exchanged between the device and the calculating device in accordance with the address conversion table.

7. A frame control method of a route switch, connected to a plurality of storage devices housed in enclosures thereof, for controlling a frame exchanged between each of the enclosures and a calculating device, the enclosure being connected to at least two communication lines different in path from each other extending between the route switch and the enclosure, the frame control method comprising:
a fault detecting step of detecting a fault on the communication line extending to the enclosure,
a table generating step of generating an address conversion table, the address conversion table mapping, based on the detection results of the fault detecting step, a first address indicating an address of a frame reaching the enclosure via a communication line free from the fault to a second address indicating an address of the frame reaching the enclosure prior to the occurrence of the fault, and storing the address conversion table on a storage unit and
a frame control step of controlling the frame exchanged between the enclosure and the calculating device in accordance with the address conversion table stored on the storage unit.

8. The frame control method according to claim 7, wherein the frame control step includes converting the second address into the first address by comparing the second address serving as a transmission destination of the frame with the address conversion table if the frame is received from the calculating device, and outputting to the transmission destination the frame having the converted address.

9. The frame control method according to claim 8, wherein the frame control step includes converting the first address into the second address by comparing the first address serving as a transmission source of the frame with the address conversion table if the frame is received from the storage device, and outputting to the transmission destination the frame having the converted address.

10. The frame control method according to claim 7, wherein the frame control step includes converting the first address into the second address by comparing the first address serving as a transmission source of the frame with the address conversion table if the frame is received from the storage device, and outputting to the transmission destination the frame having the converted address.

11. The frame control method according to claim 7, further including a communication performance monitoring step of monitoring a drop in communication performance of the communication line extending to the storage device, and a modification table generating step of generating an address modification table, the address modification table mapping the second address to a third address, to which the address of the frame is modified so that the path of the communication line of the frame reaching the storage device is diverged, wherein the frame control step includes controlling the frame exchanged between the storage device and the calculating device in accordance with the address modification table.

12. A storage system comprising:
a calculating device;
a plurality of storage devices; and
a route switch, connected to the storage devices, for controlling a frame exchanged between the storage device and the calculating device, the storage device being connected to at least two communication lines different in path from each other extending between the route switch and the storage device,
the route switch including
fault detecting means for detecting a fault on the communication line extending to the storage device,
table generating means for generating an address conversion table, the address conversion table mapping, based on the detection results of the fault detecting means, a first address indicating an address of a frame reaching the storage device via a communication line free from the fault to a second address indicating an address of the frame reaching the storage device prior to the occurrence of the fault, and
frame control means for controlling the frame exchanged between the storage device and the calculating device in accordance with the address conversion table.
